(19) United States
(12) Patent Application Publication
(10) Pub. No.: US 2015/0045983 A1
(43) Pub. Date: Feb. 12, 2015

(54) Methods, Systems and Devices for Obtaining and Utilizing Vehicle Telematics Data

(71) Applicant: DriveFactor, Glen Allen, VA (US)

(72) Inventors: MacGregor Fraser, Rockville, VA (US); John Milam Walters, Richmond, VA (US)

(73) Assignee: DriveFactor, Glen Allen, VA (US)

(21) Appl. No.: 13/961,797

(22) Filed: Aug. 7, 2013

(51) Int. Cl. G07C 5/00

(52) U.S. Cl. CPC G07C 5/008
USPC 701/1

(57) ABSTRACT

Certain embodiments of this disclosure include methods, systems and devices for obtaining and utilizing vehicle telematics data. According to one embodiment, a method is provided. The method may include: (i) obtaining, from at least one sensor located in a telematics device, telematics device sensor data, wherein the telematics device sensor data comprises data describing one or more characteristics of a vehicle associated with the telematics device; (ii) transmitting, by the telematics device, the telematics device sensor data to a mobile device; (iii) obtaining, from at least one sensor located in the mobile device, mobile device sensor data, wherein the mobile device sensor data comprises data describing one or more different characteristics of the vehicle; and (iv) transmitting, by the mobile device, the telematics device sensor data and the mobile device sensor data to a remote computing device for processing.

### FIELD

The present invention relates generally to data acquisition, processing and communicating systems, and more particularly, to a system for obtaining telematics data from a plurality of sensors housed in a plurality of different devices.

### BACKGROUND

Presently, several systems and techniques exist for obtaining vehicle telematics data. As known in the art, vehicle telematics data may include, but is not limited to, data describing one or more characteristics associated with a vehicle. For example, vehicle telematics data may include information describing a vehicle's location, a vehicle's speed, a vehicle's acceleration, a vehicle's direction, a vehicle's orientation (i.e., relative to a horizontal and/or vertical plane), etc. In addition, vehicle telematics data may include information about the state of one or more components of the vehicle. For example, vehicle telematics data may include data describing the vehicle's engine's revolutions per minute (RPM), the heat of the vehicle's engine, information describing whether or not a vehicle's headlights or windshield wipers are in operation, information describing the tire pressure in the vehicle's tires, information describing the amount of fuel in the vehicle's gas tank, etc. The foregoing examples are merely exemplary in nature and it is recognized that vehicle telematics data may include any additional information concerning a vehicle as known by those having ordinary skill in the art.

Conventional systems for obtaining vehicle telematics data may be broadly characterized as falling into two categories: (1) systems that interface with a vehicle's on-board-diagnostics interface (e.g., OBD, OBD-II, etc.) and (2) systems that rely solely on sensor data obtained from a single mobile device such as a smartphone, personal digital assistant (PDA), cellular phone, tablet, etc. While these conventional systems are sufficient for performing some vehicle telematics data acquisition and analysis, they suffer from a number of drawbacks.

With regard to the first category of vehicle telematics data systems set forth above, these systems frequently include a device that plugs into a vehicle's on-board-diagnostics port. The device is configured to obtain data regarding the vehicle generally, and the vehicle's sub-components specifically, from the vehicle's on-board computer through the port. Frequently, the obtained data is transmitted over a wireless network to a server where it is utilized for one or more purposes (e.g., to determine driver risk so as to affect insurance costs, to monitor a vehicle's location, to monitor a vehicle for safety reasons, such as to determine whether a vehicle has been in an accident, etc.). Despite the generally utility of such systems, these systems also are associated with several problems.

First, these systems require a device that has a specialized on-board-diagnostics interface designed to connect with a vehicle's OBD port. Devices designed to connect with vehicle's OBD ports are quite costly because of the complexity of the interface. Moreover, different vehicle's have different types of OBD interfaces. Accordingly, a telematics data system device designed to interface with a particular type of OBD port (e.g., an OBD-I port) may not be able to suitably interface with a different type of OBD port (e.g., an OBD-II port). Second, these systems require specialized transmission costs. That is to say, these systems frequently require a user to enroll in a wireless transmission service program so as to transmit the obtained vehicle telematics data to the remote server for further processing. Accordingly, these systems can be quite costly. Third, the OBD port is often difficult to locate within a vehicle. As such, a user attempting to install such a device may often have to spend an inordinate amount of time locating the OBD port before the system can begin functioning properly. Finally, these systems can often interfere with the operation of the vehicle in which they are installed. For example, it has been discovered that pulling data through a vehicle's OBD port can negatively affect the operation of vehicle subsystems, causing radios to fail, speedometers to malfunction, and in the most sever instances, engines to stop.

With regard to the second category of vehicle telematics data systems set forth above, these systems frequently include the use of a mobile device. Specifically, these types of systems utilize the sensor data gathered from the different sensors that are frequently included in many standard mobile devices. The gathered sensor data may be processed using specialized software installed on the device, and may be transmitted via the mobile device to a remote server computer for further processing. However, there are several shortcomings associated with these systems as well. First, the software installed on the mobile device that controls execution of the system assumes that the mobile device has all of the sensors necessary to obtain the requisite sensor data. For instance, the software utilized in these types of system often assumes that the mobile device includes a GPS sensor, a magnetometer, an accelerometer, a gyroscope, etc. However, many mobile devices, especially older model mobile devices, simply do not include a full sensor array. Second, even in those mobile devices that do include a sensor array, the sensors are often of low-quality due to size and cost constraints of the mobile device. Accordingly, the quality of sensor data gathered from these low-quality sensors is often sub-par at best, and limits the system's ability to acquire accurate vehicle telematics data. Third, these systems frequently lack anchor mechanisms designed to hold the mobile device firmly in place while its sensors gather data. Because the mobile device is often free to slide around in these types of systems, the accuracy of the gathered sensor data may be compromised. Finally, activation and monitoring of a complete sensor array within a mobile device is extremely battery-intensive. This can cause the mobile device's battery to die, thereby eviscerating the effectiveness of the system entirely.

Accordingly, there is a need for a new technology aimed at addressing one or more of the drawbacks associated with conventional techniques for obtaining and utilizing vehicle telematics data.

### SUMMARY

The instant disclosure describes methods, systems, and devices for obtaining and utilizing vehicle telematics data. To this end, in one example, a method is provided. The method includes obtaining telematics device sensor data. The telematics device sensor data may be obtained from at least one sensor located in a telematics device. The telematics device sensor data may include data describing one or more characteristics of a vehicle associated with the telematics device. The method may further include transmitting, by the telematics device, the telematics device sensor data to a mobile device. Additionally, the method may include obtaining, from at least one sensor located in the mobile device, mobile device sensor data. The mobile device sensor data may include data describing one or more different characteristics of the vehicle. Finally, in this example, the method may include transmitting, by the mobile device, the telematics device sensor data and the mobile device sensor data to a remote computing device for processing.

In one example, the method may additionally include (i) analyzing, by the remote computing device, the telematics device sensor data and the mobile device sensor data and (ii) generating, by the remote computing device, vehicle make and model data based on the telematics device sensor data and the mobile device sensor data. The vehicle make and model data may include data describing a manufacturer of the vehicle, a year of the vehicle, and a model of the vehicle. In one example, the telematics device sensor data and the mobile device sensor data may include one or more numerical values. In this example, analyzing the telematics device sensor data and the mobile device sensor data may include comparing the one or more numerical values with corresponding one or more vehicle profile numerical values stored in a vehicle profile database.

In one example, the method may additionally include (i) processing, by one or more processors located in the mobile device, the telematics device sensor data and the mobile device sensor to provide display data and (ii) outputting, for display, the display data.

In one example, the telematics device sensor data includes one or more of the following types of data: (i) accelerometer data obtained from an accelerometer sensor located in the telematics device that describes acceleration of the vehicle at one or more points in time; (ii) gyroscope data obtained from a gyroscope sensor located in the telematics device that describes an orientation of the vehicle at one or more points in time; (iii) magnetometer data obtained from a magnetometer sensor located in the telematics device that describes a direction of the vehicle at one or more points in time; and/or (iv) location data obtained from a location-detecting sensor located in the telematics device that describes a location of the vehicle at one or more points in time. In another example, the mobile device sensor data may include any, all, or none of the foregoing types of data.

In one example, the method may also include installing the telematics device in the vehicle. In this example, the installation may include connecting a vehicle interface portion of the telematics device to a telematics interface portion of the vehicle. In another example, the method may include uninstalling the telematics device from the vehicle. In this example, the uninstalling may include disconnecting the vehicle interface portion of the telematics device from the telematics interface portion of the vehicle and switching a power source for the telematics device from a first power source external to the telematics device to a second power source internal to the telematics device.

In one example, transmitting the telematics device sensor data to the mobile device may include (i) transmitting the telematics device sensor data via a wireless communication channel or (ii) transmitting the telematics device sensor data via a universal serial bus (USB) communication channel.

In yet another example, the method may include compressing at least one of the telematics device sensor data and the mobile device sensor data. In another example, the method may also include encrypting at least one of the telematics device sensor data and the mobile device sensor data.

In another example, the method may include adjusting a rate at which the telematics device data is obtained from the at least one sensor located in the telematics device. In still another example, the method may include adjusting a rate at which the mobile device data is obtained from the at least one sensor located in the mobile device.

Related telematics devices, mobile devices, systems, and computer-readable media for use in carrying out the above-described method are also provided. These and other objects, features, and advantages of the foregoing methods, devices, systems, and computer-readable media will become more apparent upon reading the following specification in conjunction with the accompanying drawing figures.

### BRIEF DESCRIPTION OF THE FIGURES

Reference will now be made to the accompanying figures and flow diagrams, which are not necessarily drawn to scale, and wherein:

FIG. 1 is a block diagram illustrating one example of a computing device (e.g., mobile device) suitable for use in obtaining and utilizing vehicle telematics data in accordance with the disclosed technology.

FIG. 2 is a block diagram illustrating one example of a system suitable for use in obtaining and utilizing vehicle telematics data in accordance with the disclosed technology.

FIG. 3 is a block diagram illustrating one example of a telematics device suitable for use in obtaining and utilizing vehicle telematics data in accordance with the disclosed technology.

FIG. 4 is a block diagram illustrating one example of a mobile device suitable for use in obtaining and utilizing vehicle telematics data in accordance with the disclosed technology.

FIG. 5 is a block diagram illustrating one example of a remote computing device suitable for use in analyzing vehicle telematics data in accordance with the disclosed technology.

FIG. 6a is an orthographic view of one example of a telematics device suitable for use in obtaining and utilizing vehicle telematics data in accordance with the disclosed technology.

FIG. 6b is a rear view of one example of a telematics device suitable for use in obtaining and utilizing vehicle telematics data in accordance with the disclosed technology.

FIG. 6c is a top view of one example of a telematics device suitable for use in obtaining and utilizing vehicle telematics data in accordance with the disclosed technology.

FIG. 6d is a front view of one example of a telematics device suitable for use in obtaining and utilizing vehicle telematics data in accordance with the disclosed technology.

FIG. 7a is an orthographic view of one example of a telematics device connected to a universal serial bus communication channel suitable for use in obtaining and utilizing vehicle telematics data in accordance with the disclosed technology.

FIG. 7b is an orthographic section view of one example of a telematics device connected to a universal serial bus communication channel suitable for use in obtaining and utilizing vehicle telematics data in accordance with the disclosed technology.

FIG. 8 is a flow diagram illustrating a method for obtaining and utilizing vehicle telematics data according to one embodiment of the disclosed technology.

FIG. 9 is a flow diagram illustrating another method for obtaining and utilizing vehicle telematics data according to one embodiment of the disclosed technology.

FIG. 10 is a flow diagram illustrating a method for determining the angle of tilt between a telematics device installed in a vehicle and a vertical plane according to one embodiment of the disclosed technology.

FIG. 11 is a flow diagram illustrating a method for determining whether a vehicle in which a telematics device is installed executed a turn or merely executed a lane change according to one embodiment of the disclosed technology.

FIG. 12 is a diagram illustrating sensor orientation and gravity calibration for orienting and calibrating the one or more sensors in the telematics device and/or mobile device according to one embodiment of the disclosed technology.

FIG. 13 is a diagram illustrating angles used in the calibration of a telematics device of unknown orientation to the chassis of a moving vehicle.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

Various embodiments of the disclosed technology provide methods, devices, systems and computer-readable media for obtaining and utilizing vehicle telematics data. In one example embodiment, a method for obtaining and utilizing vehicle telematics data is provided. The method may include: (i) obtaining, from at least one sensor located in a telematics device, telematics device sensor data, wherein the telematics device sensor data comprises data describing one or more characteristics of a vehicle associated with the telematics device; (ii) transmitting, by the telematics device, the telematics device sensor data to a mobile device; (iii) obtaining, from at least one sensor located in the mobile device, mobile device sensor data, wherein the mobile device sensor data comprises data describing one or more different characteristics of the vehicle; and (iv) transmitting, by the mobile device, the telematics device sensor data and the mobile device sensor data to a remote computing device for processing.

In another example embodiment, a computer-readable medium encoded with a computer program is provided. The computer program may include computer-executable instructions that when executed by a computer having at least one processor causes the computer to perform a method that may include: (i) obtaining telematics device sensor data from a telematics device, wherein the telematics device sensor data comprises data describing one or more characteristics of a vehicle associated with the telematics device; (ii) obtaining mobile device sensor data, wherein the mobile device sensor data comprises data describing one or more different characteristics of the vehicle; (iii) processing the telematics device sensor data and the mobile device sensor data to provide display data; and (iv) outputting, for display, the display data.

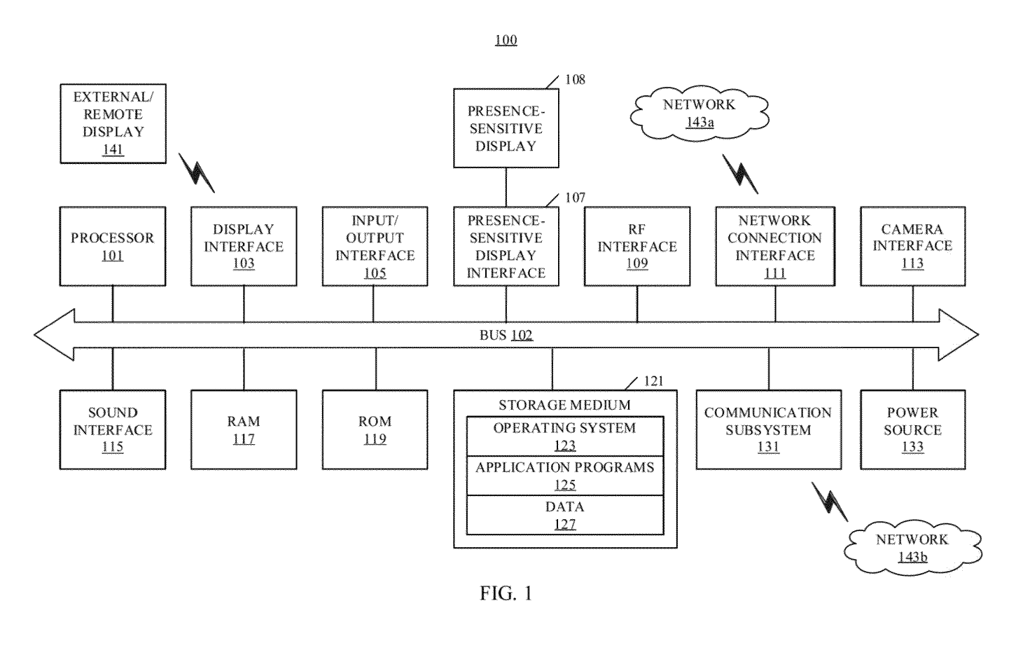

According to one example implementation, the terms computing device or mobile computing device, as used herein, may be a central processing unit (CPU), controller or processor, or may be conceptualized as a CPU, controller or processor (for example, the processor 101 of FIG. 1). In yet other instances, a computing device may be a CPU, controller or processor combined with one or more additional hardware components. In certain example implementations, the computing device operating as a CPU, controller or processor may be operatively coupled with one or more peripheral devices, such as a display, navigation system, stereo, entertainment center, Wi-Fi access point, or the like. In another example implementation, the term computing device, as used herein, may refer to a mobile computing device, such as a smartphone, mobile station (MS), terminal, cellular phone, cellular handset, personal digital assistant (PDA), smartphone, wireless phone, organizer, handheld computer, desktop computer, laptop computer, tablet computer, set-top box, television, appliance, game device, medical device, display device, or some other like terminology. In an example embodiment, the computing device may output content to its local display or speaker(s). In another example implementation, the computing device may output content to an external display device (e.g., over Wi-Fi) such as a TV or an external computing system.

FIG. 1 is a block diagram illustrating one embodiment of a computing device 100 in accordance with various aspects set forth herein. The computing device 100 represents possible configurations for the telematics device 206, the mobile device 208, and/or the remote computing device 212, each of which are described in additional detail below. That is to say, the telematics device 206, the mobile device 208, and/or the remote computing device 212 could each include all or some of the components described with regard to the computing device 100.

Regardless, as shown in FIG. 1, the computing device 100 may be configured to include a processor 101, which may also be referred to as a computing device, that is operatively coupled to a display interface 103, an input/output interface 105, a presence-sensitive display interface 107, a radio frequency (RF) interface 109, a network connection interface 111, a camera interface 113, a sound interface 115, a random access memory (RAM) 117, a read only memory (ROM) 119, a storage medium 121, an operating system 123, an application program 125, data 127, a communication subsystem 131, a power source 133, another element, or any combination thereof. In FIG. 1, the processor 101 may be configured to process computer instructions and data. The processor 101 may be configured to be a computer processor or a controller. For example, the processor 101 may include two computer processors. In one definition, data is information in a form suitable for use by a computer. It is important to note that a person having ordinary skill in the art will recognize that the subject matter of this disclosure may be implemented using various operating systems or combinations of operating systems.

In FIG. 1, the display interface 103 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia interface (HDMI) port, a video port, an audio port, a Bluetooth port, a near-field communication (NFC) port, another like communication interface, or any combination thereof. In one example, the display interface 103 may be operatively coupled to a local display, such as a touch-screen display associated with a mobile device. In another example, the display interface 103 may be configured to provide video, graphics, images, text, other information, or any combination thereof for an external/remote display 141 that is not necessarily connected to the mobile computing device. In one example, a desktop monitor may be utilized for mirroring or extending graphical information that may be presented on a mobile device. In another example, the display interface 103 may wirelessly communicate, for example, via the network connection interface 111 such as a Wi-Fi transceiver to the external/remote display 141.

In the current embodiment, the input/output interface 105 may be configured to provide a communication interface to an input device, output device, or input and output device. The computing device 100 may be configured to use an output device via the input/output interface 105. A person of ordinary skill will recognize that an output device may use the same type of interface port as an input device. For example, a USB port may be used to provide input to and output from the computing device 100. The output device may be a speaker, a sound card, a video card, a display, a monitor, a printer, an actuator, an emitter, a smartcard, another output device, or any combination thereof. The computing device 100 may be configured to use an input device via the input/output interface 105 to allow a user to capture information into the computing device 100. The input device may include a mouse, a trackball, a directional pad, a trackpad, a presence-sensitive input device, a presence-sensitive display, a scroll wheel, a digital camera, a digital video camera, a web camera, a microphone, a sensor, a smartcard, and the like. The presence-sensitive input device may include a digital camera, a digital video camera, a web camera, a microphone, a sensor, or the like to sense input from a user. The presence-sensitive input device may be combined with a display to form a presence-sensitive display. Further, the presence-sensitive input device may be coupled to the computing device. The sensor may be, for instance, an accelerometer, a gyroscope, a tilt sensor, a force sensor, a magnetometer, an optical sensor, a proximity sensor, another like sensor, or any combination thereof. For example, the input device 115 may be an accelerometer, a magnetometer, a digital camera, a microphone, and an optical sensor.

In FIG. 1, the presence-sensitive display interface 107 may be configured to provide a communication interface to a pointing device or a presence-sensitive display 108 such as a touch screen. In one definition, a presence-sensitive display is an electronic visual display that may detect the presence and location of a touch, gesture, or object near its display area. In one definition, the term “near” means on, proximate or associated with. In another definition, the term “near” is the extended spatial location of. The RF interface 109 may be configured to provide a communication interface to RF components such as a transmitter, a receiver, and an antenna. The network connection interface 111 may be configured to provide a communication interface to a network 143a. The network 143a may encompass wired and wireless communication networks such as a local-area network (LAN), a wide-area network (WAN), a computer network, a wireless network, a telecommunications network, another like network or any combination thereof. For example, the network 143a may be a cellular network, a Wi-Fi network, and a near-field network. As previously discussed, the display interface 103 may be in communication with the network connection interface 111, for example, to provide information for display on a remote display that is operatively coupled to the computing device 100. The camera interface 113 may be configured to provide a communication interface and functions for capturing digital images or video from a camera. The sound interface 115 may be configured to provide a communication interface to a microphone or speaker.

In this embodiment, the RAM 117 may be configured to interface via the bus 102 to the processor 101 to provide storage or caching of data or computer instructions during the execution of software programs such as the operating system, application programs, and device drivers. In one example, the computing device 100 may include at least one hundred and twenty-eight megabytes (128 Mbytes) of RAM. The ROM 119 may be configured to provide computer instructions or data to the processor 101. For example, the ROM 119 may be configured to be invariant low-level system code or data for basic system functions such as basic input and output (I/O), startup, or reception of keystrokes from a keyboard that are stored in a non-volatile memory. The storage medium 121 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives. In one example, the storage medium 121 may be configured to include an operating system 123, an application program 125 such as a web browser application, a widget or gadget engine or another application, and a data file 127.

In FIG. 1, the computing device 101 may be configured to communicate with a network 143b using the communication subsystem 131. The network 143a and the network 143b may be the same network or networks or different network or networks. The communication functions of the communication subsystem 131 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 131 may include cellular communication, Wi-Fi communication, Bluetooth communication, and GPS communication. The network 143b may encompass wired and wireless communication networks such as a local-area network (LAN), a wide-area network (WAN), a computer network, a wireless network, a telecommunications network, another like network or any combination thereof. For example, the network 143b may be a cellular network, a Wi-Fi network, and a near-field network. The power source 133 may be configured to provide an alternating current (AC) or direct current (DC) power to components of the computing device 100.

In FIG. 1, the storage medium 121 may be configured to include a number of physical drive units, such as a redundant array of independent disks (RAID), a floppy disk drive, a flash memory, a USB flash drive, an external hard disk drive, thumb drive, pen drive, key drive, a high-density digital versatile disc (HD-DVD) optical disc drive, an internal hard disk drive, a Blu-Ray optical disc drive, a holographic digital data storage (HDDS) optical disc drive, an external mini-dual in-line memory module (DIMM) synchronous dynamic random access memory (SDRAM), an external micro-DIMM SDRAM, a smartcard memory such as a subscriber identity module or a removable user identity (SIM/RUIM) module, other memory, or any combination thereof. The storage medium 121 may allow the computing device 100 to access computer-executable instructions, application programs or the like, stored on transitory or non-transitory memory media, to off-load data, or to upload data. An article of manufacture, such as one utilizing a communication system may be tangibly embodied in storage medium 122, which may comprise a computer-readable medium.

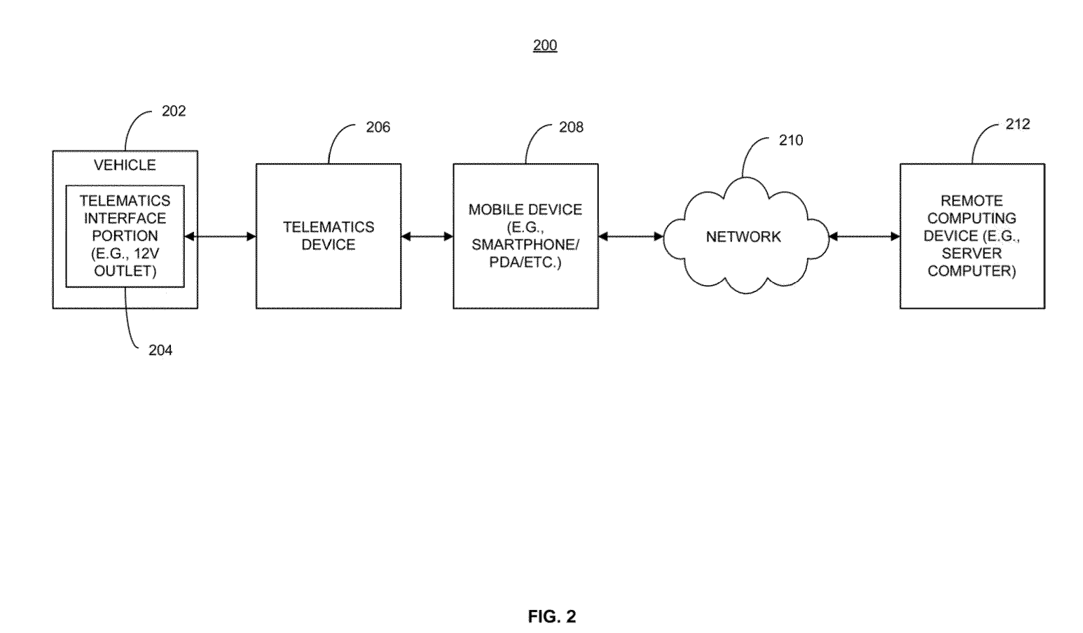

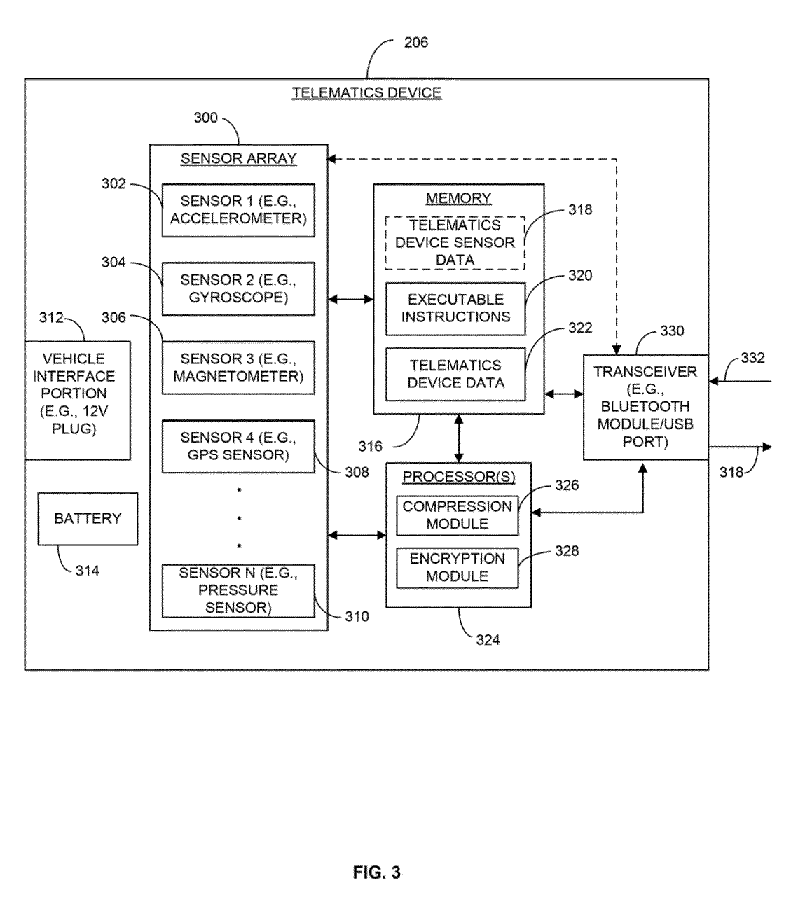

FIG. 2 is a block diagram illustrating one example of a system 200 suitable for use in obtaining and utilizing vehicle telematics data in accordance with the disclosed technology. The system 200 a telematics device 206, a mobile device 208 operatively connected to the telematics device (i.e., connected via one or more wired or wireless communication channels), a network 210 (e.g., the internet, a cellular network, etc.), and a remote computing device 212 operatively connected to the mobile device via the network 210. Although not technically part of the system 200, FIG. 1 also illustrates a vehicle 202 (e.g., a car, train, plane, boat, shipping container, etc.) that includes a telematics interface portion 204 for operative connection to the telematics device 206. In one example, the telematics interface portion 204 may include an on-board-diagnostics port (e.g., OBD, OBD-II, etc.). In another example, the telematics interface portion 204 may include a 12V power outlet, such as the cigarette lighter power outlet located in many models of vehicles. The operation and design of each of the respective components of system 200 are described below with regard to FIGS. 3-12.

Referring now to FIG. 3, a block diagram of one example of the telematics device 206 is shown. The telematics device 206 may include a sensor array 300, a vehicle interface portion 312, a battery 314, memory 316, one or more processors 324 and one or more transceivers 330.

In one example, the vehicle interface portion 312 includes a 12V plug configured to securely mate with a 12V power outlet, such as a cigarette lighter. Thus, in this example, the vehicle interface portion 312 may be inserted into the 12V outlet of a vehicle in order to securely fasten the telematics device 206 to the vehicle. In one example, the vehicle interface portion 312 is a 12V plug, wherein the plug includes means for securely connecting the vehicle interface portion 312 of the telematics device 206 with the telematics interface portion of the vehicle 204. In one example, the means include gripping tape disposed on the surface of the plug so as to create adhesive contact between the outer perimeter of the plug and the interior of the 12V outlet. In another example, the means include rubber pads disposed on the surface of the plug so as to create frictional contact between the outer perimeter of the plug and the interior of the 12V outlet. Connecting the vehicle interface portion 312 of the telematics device 206 to the telematics interface portion of the vehicle 204 serves at least three purposes. First, this connection ensures that the telematics device 206 does not shift around when the vehicle 202 is in motion. This enhances the accuracy and reliability of the telematics device sensor data 318 that is obtained from the sensor array 300. Second, this connection permits power to be provided to the telematics device 206 when the battery 314 is not active. Third, this connection permits power to be transferred from the telematics interface portion of the vehicle 204 to a mobile device 208 that is connected via a wire to the telematics device 206. In this manner, a mobile device 208 such as a smartphone may be powered, or have its battery charged, via the telematics device 206.

The sensor array 300 includes one or more sensors 302-310. Although FIG. 3 only shows five sensors 302-310, those having ordinary skill in the art will recognize that more or less sensors may be included as part of the sensor array 300 without deviating from the teachings of the instant disclosure. In one example, the sensor array 300 includes an accelerometer 302, a gyroscope 304, a location sensor 306, a magnetometer 308, and a pressure sensor 310. The accelerometer 302 is configured to generate accelerometer data that describes the acceleration of the vehicle 202 at one or more points in time. The gyroscope 304 is configured to generate gyroscope data that describes the orientation of the vehicle 202 at one or more points in time. The magnetometer 308 is configured to generate magnetometer data that describes a direction of the vehicle 202 at one or more points in time. The location sensor 306 (e.g., a GPS sensor) is configured to generate location data that describes a location of the vehicle 202 at one or more points in time. The pressure sensor 308 is configured to generate pressure data describing the pressure in the area proximate to the vehicle 202. Accordingly, the sensor array 300 is configured to generate telematics device sensor data 316, which data 316 includes one or more of the foregoing types of data depending upon which types of sensors are actually included and activated in the telematics device 206 at any given time.

The telematics device 206 may also include memory 316 operatively connected to the sensory array 300, one or more processors 324, one or more transceivers 330, and the battery 314 (connection not shown for purposes of simplicity). The memory 316 may store, for example, the telematics device sensor data 316, executable instructions 320, and telematics device data 322. In one example, the memory 316 includes non-volatile memory configured to store the executable instructions 320 and telematics device data 322, which collectively, define the operation of the telematics device 206 in line with the functionality described herein.

The telematics device 206 may also include one or more processors 324 operatively connected to the memory 316, the sensor array 300, the one or more transceivers 330, and the battery 314 (connection not shown for purposes of simplicity). In one example, the processor(s) 324 are configured to execute the executable instructions 320 and operate on the telematics device data 322 in order to instantiate a compression module 326 configured to compress the telematics device sensor data 318 using data compression techniques known in the art. In another example, the processor(s) 324 are configured to execute the executable instructions 320 and operate on the telematics device data 322 in order to instantiate an encryption module 328 configured to encrypt the telematics device sensor data 318 using data encryption techniques known in the art.

The transceiver(s) 330 of the telematics device 206 are operatively connected to the sensor array 300 (in one embodiment), the memory 316, and the processor(s) 324. In one example, the transceiver(s) 330 include a short-wave communication module (e.g., a Bluetooth module) configured to wirelessly transmit the telematics device sensor data 318 to an external device, such as the mobile device 208. In another example, the transceiver(s) 330 include a wired communication port (e.g., a USB port) configured to transmit the telematics device sensor data 318 to an external device, such as the mobile device 208, via a wired communication channel (e.g., via a USB cable). In one example, the transceiver(s) 330 are configured to obtain over-the-air (OTA) instructions 332 via wired or wireless communication. The OTA instructions 332 may modify the operation of the telematics device 206 by, for example, supplementing, replacing, or altering the executable instructions 320 and/or the telematics device data 322. In one example, the OTA instructions 332 may be configured to adjust the rate at which the telematics device sensor data 318 is obtained from the sensors 302-310. For example, the sensors 302-310 may initially only capture sensor reading every second. The OTA instructions 332 may adjust the frequency with which sensor readings are captured, such that sensor readings are subsequently captured every half-second. Of course, the foregoing is but merely one example and it is contemplated that the OTA instructions 332 may adjust the rate at which sensor data 318 is obtained to any suitable rate.

The battery 314 may include any suitable type of battery known in the art, such as, for example, one or more capacitors. Accordingly, the battery 314 may supply power to one or more of the telematics device components even when the telematics device 206 is not connected to the telematics interface portion 204 of the vehicle 202. In one example, the battery 314 plays an important role when the telematics device 206 is uninstalled from the vehicle 202. Specifically, when the telematics device 206 is uninstalled (e.g., when a user disconnects the vehicle interface portion 312 of the telematics device 206 from the telematics interface portion of the vehicle 204), the telematics device can no longer receive power from the telematics interface portion of the vehicle 204 (e.g., the 12V outlet). However, in such a scenario, the telematics device 206 is configured to switch its power source from the telematics interface portion of the vehicle 204 to the battery 314. In this manner, the telematics device 206 may continue to operate even when it is unplugged.

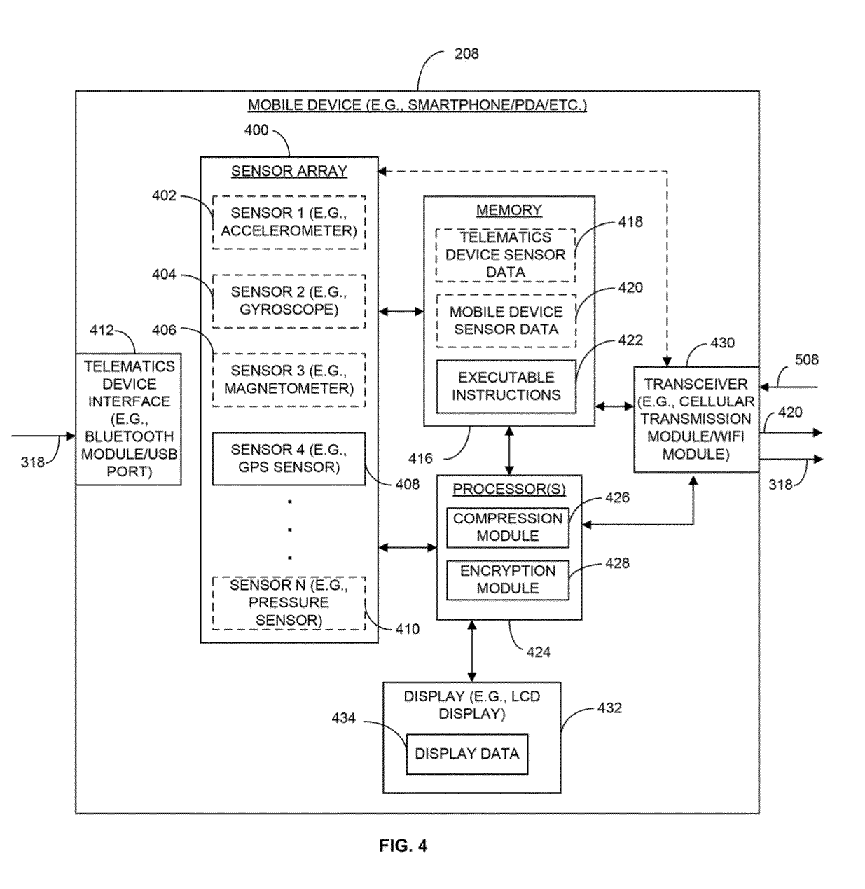

Referring now to FIG. 4, a block diagram illustrating one example of a mobile device 208 suitable for use in obtaining and utilizing vehicle telematics data is shown. The mobile device 208 may include a sensor array 400, a telematics device interface portion 412, memory 416, one or more processors 424, one or more transceivers 430, and a display 432.

In one example, the telematics device interface portion 412 includes a short-wave communication module (e.g., a Bluetooth module) configured to wirelessly receive the telematics device sensor data 318 from an external device, such as the telematics device 206. In another example, the telematics device interface portion 412 includes a wired communication port (e.g., a USB port) configured to receive the telematics device sensor data 318 from an external device, such as the telematics device 206, via a wired communication channel (e.g., via a USB cable).

The sensor array 400 includes one or more sensors 402-410. Although FIG. 4 only shows five sensors 402-410, those having ordinary skill in the art will recognize that more or less sensors may be included as part of the sensor array 400 without deviating from the teachings of the instant disclosure. In one example, the sensor array 400 includes an accelerometer 402, a gyroscope 404, a location sensor 406, a magnetometer 408, and a pressure sensor 410. The accelerometer 402 is configured to generate accelerometer data that describes the acceleration of the vehicle 202 at one or more points in time. The gyroscope 404 is configured to generate gyroscope data that describes the orientation of the vehicle 202 at one or more points in time. The magnetometer 408 is configured to generate magnetometer data that describes a direction of the vehicle 202 at one or more points in time. The location sensor 406 (e.g., a GPS sensor) is configured to generate location data that describes a location of the vehicle 202 at one or more points in time. The pressure sensor 408 is configured to generate pressure data describing the pressure in the area proximate to the vehicle 202. Accordingly, the sensor array 400 is configured to generate mobile device sensor data 420, which data 420 includes one or more of the foregoing types of data depending upon which types of sensors are actually included and activated in the mobile device 208 at any given time.

Additionally, in one embodiment, no mobile device sensor data 420 is captured from any of the sensors in the mobile device sensor array 400—without negatively affecting operation of the system 200. This is because, in such an embodiment, the sensors 300 located in the telematics device 206 can be used to capture the same types of data (e.g., accelerometer data, gyroscope data, magnetometer data, location data, etc.). Indeed, in many instances, the telematics device sensor data 318 may be more accurate and reliable than the mobile device sensor data 420 because the telematics device 206 may include higher quality sensors 300 than the sensors 400 included in the mobile device 208. In this embodiment, the mobile device may still carry out useful processes such as data compression and/or encryption (as discussed below) and data transmission to the remote computing device 212. Moreover, this embodiment may conserve battery life on the mobile device 208 by de-activating one or more of the energy-expensive sensors 400.

In another embodiment, the mobile device sensor data 420 includes data from at least one, but not all, of the sensors 400. For example, in one embodiment, only the location sensor 406 (e.g., a GPS sensor) captures data that is included as part of the mobile device sensor data 420. As noted above, by utilizing some, but not all of the sensors 400, battery life can be conserved. Further, given the duplicity of the information captured by sensors 300 and sensors 400, it is often inefficient to have all of the sensors 300 located in the telematics device 206 and all of the sensors 400 located in the mobile device 208 capturing data simultaneously.

The mobile device 208 may also include memory 416 operatively connected to the sensory array 400, one or more processors 424, and one or more transceivers 430. The memory 416 may store, for example, the telematics device sensor data 316, the mobile device sensor data 420, and executable instructions 422.

The mobile device 208 may also include one or more processors 424 operatively connected to the memory 416, the sensor array 400, the one or more transceivers 430, and the display 432. In one example, the processor(s) 424 are configured to execute the executable instructions 422 and operate on other data (not shown) in order to instantiate a compression module 426 configured to compress the telematics device sensor data 318 and/or the mobile device sensor data 420 using data compression techniques known in the art. In another example, the processor(s) 424 are configured to execute the executable instructions 422 and operate on other data (not shown) in order to instantiate an encryption module 428 configured to encrypt the telematics device sensor data 318 and/or the mobile device sensor data 420 using data encryption techniques known in the art. In one example, the processor(s) are configured to process the telematics device sensor data 318 and/or the mobile device sensor data 420 to generate display data 434 (e.g., pixel data) for display on the display device 432. The display data 434 may include, for example, one or more graphical user interfaces (GUIs) permitting users of the mobile phone to analyze and interact with the telematics device sensor data 318 and/or the mobile device sensor data 420. In another example, the mobile device is configured to receive OTA instructions (not shown) via, for example, the transceiver(s) 430 or the telematics device interface 412. The OTA instructions may be configured to, for example, adjust the rate at which the mobile device sensor data 420 is obtained from the sensors 400.

The transceiver(s) 430 of the mobile device 208 are operatively connected to the sensor array 400 (in one embodiment), the memory 416, and the processor(s) 424. The transceiver(s) 430 are configured to transmit the telematics device sensor data 318 and the mobile device sensor data 420 to the remote computing device 212 for processing. In one example, the transceiver(s) may transmit the telematics device sensor data 318 and the mobile device sensor data 420 over one or more cellular networks. In another example, the transceiver(s) may transmit the telematics device sensor data 318 and the mobile device sensor data 420 over one or more Wi-Fi networks. Of course, any other suitable communication protocols may also be used within the scope of the instant disclosure. Finally, the transceiver(s) 430 are configured to receive, from the remote computing device 212, vehicle make and model data 508, as described in additional detail below.

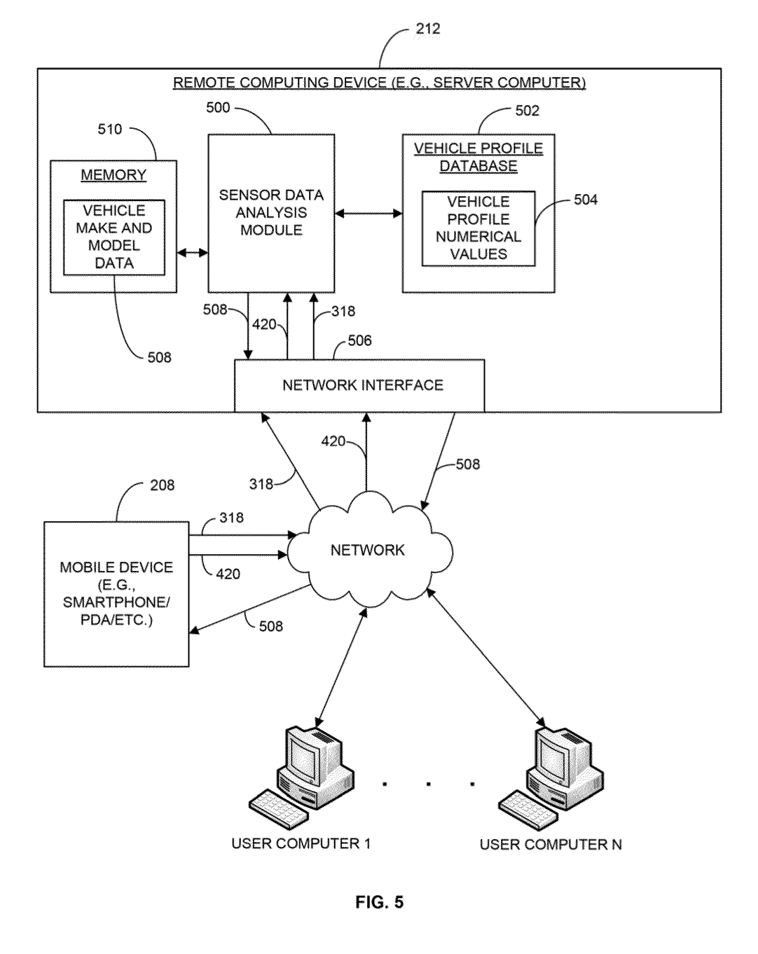

Referring now to FIG. 5, a block diagram illustrating one example of a remote computing device 212 suitable for use in analyzing vehicle telematics data is provided. As shown, the remote computing device 212 may include a sensor data analysis module 500, a vehicle profile database 502, memory 510 and a network interface 506. In order to assist in understanding the operability of the remote computing device 212, it is shown in a network environment, whereby the remote computing device 212 is shown in network connection with the mobile device 208 and one or more user computers (shown as User Computer 1 through User Computer N). In one example, the remote computing device 212 is a server computer or the like, although this is not required and the remote computing device 212 may be implemented in line with the discussion of the computing device set forth with regard to FIG. 1 herein.

The sensor data analysis module 500 of the remote computing device 212 is configured to analyze the telematics device sensor data 318 and the mobile device sensor data 420 that is transmitted by the mobile device 208 over the network 210. While several different types of analysis may be performed (e.g., analyzing the sensor data 318, 420 to assess the driving behavior of a driver of the vehicle 202 in order to calculate a driver risk which may be used to affect insurance costs), in one embodiment, the sensor data analysis module 500 is configured to determine a make and model of the vehicle 202 (i.e., a manufacturer of the vehicle such as Ford, a year of the vehicle, and a model of the vehicle such as F-150). The sensor data analysis module 500 may then generate vehicle make and model data 508 which may be transmitted back to the mobile device, to the user computers (e.g., via an internet browser), or to any other party/device as desired.

For example, in one embodiment, the telematics device sensor data 318 and the mobile device sensor data 420 include numerical values describing the sensor readings obtained from the various sensors. These numerical values may be compared against vehicle profile numerical values 504 stored in a vehicle profile database 502 operatively connected to the sensor data analysis module. In one example, the database 502 may be stored in memory, such as one or more of the memory types discussed above with regard to FIG. 1. Regardless, the vehicle profile numerical values 504 describe expected sensor reading values associated with different types of vehicles. More specifically, the vehicle make and model data 508 may be calculated as follows.

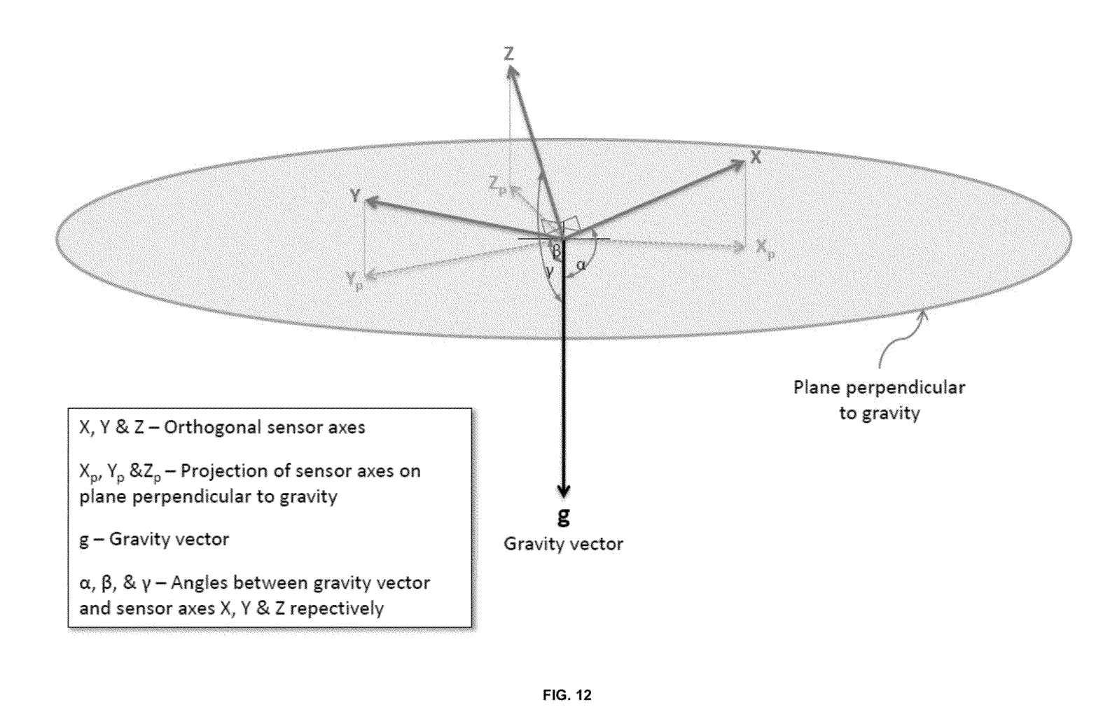

The magnetometer sensor data may be acquired from either magnetometer sensor 406 or magnetometer sensor 406. This data may be used to develop a magnetic signature of the vehicle 202, influenced by the distribution of metals and position of the telematics device 206 and/or mobile device 208 in the vehicle 202. A ferrous vehicle imparts a measurable disturbance in the earth's magnetic field. Magnetometer plots of sensor readings as the sensor turns through 360° in the absence of a distorting body (like the vehicle 202) will plot strength readings which are all approximately equidistant from zero in all degrees of rotation of the horizontal plane. When installed in an automobile, these strength readings will be distorted by the surrounding ferrous material to form an ellipse with a center offset from zero. This magnitude and direction of this shift is a signature of the vehicle in which the telematics device 206/mobile device 208 is installed. To be effective the magnetometer axes must be calibrated to compensate for tilt with the vehicle as described with regard to FIG. 12 herein. Likewise a shift of more than 10% in the value indicates installation in a different vehicle model and/or year. It is also likely that a change in orientation occurring due to telematics device 206/mobile device 208 relocation into a different attitude will cause a significant shift in the magnetometer signature, as the calibration will no longer be valid.

The accelerometer sensor data identifies forces acting on the telematics device 206/mobile device 208 in three dimensions, including gravity, accelerations due to vehicle motion and engine vibration. Subtracting out the influence of the gravity vector provides a data set that indicates the forces acting on the device accelerometer, purely due to vehicle movement. When these forces are evaluated with the vehicle at rest (that is, all magnetometer, GPS and gyroscope readings constant over a period) the accelerometers indicate the vibration of the vehicle 202 due to non-motion forces. Over time, a baseline value for this vibrational force is determined. The forces on the vehicle 202 at rest can then be compared against the baseline for an indication of physical vehicle problems, like rough-engine idle or worn-out motor mounts. Likewise, gyroscope pitch measurements as the vehicle 202 stops or starts (e.g., from GPS data) may be baselined. Subsequent readings outside of the baseline can indicate degraded shock absorbers or damaged suspension.

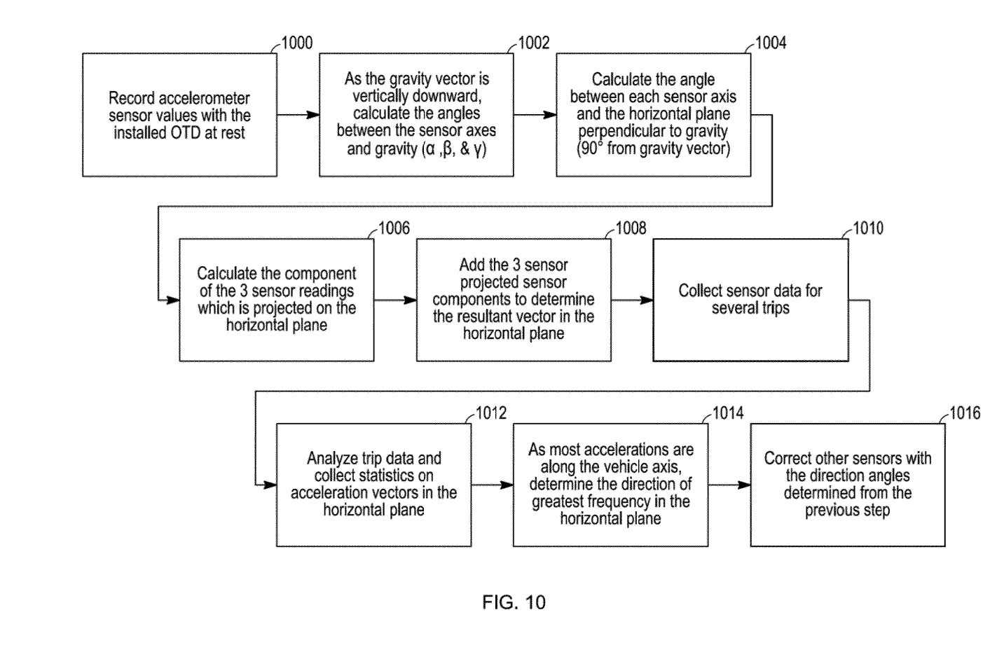

The combination of the magnetic automobile signature and accelerometer tilt indications (see FIG. 10 for a discussion on how the angle of tilt between the telematics device 206/mobile device 208 and the vertical is determined) provide a very strong correlation with vehicle manufacturer, model and year, with discernible differences between individual vehicles. Thus the process for determining a vehicle make and model may be summarized as follows: (1) collect a plurality of magnetometer readings from inside the vehicle 202 while the vehicle travels at least 360°; (2) compensate for tilt (see the discussion accompanying FIG. 10)—this provides X&Y plane values only from a three axis magnetometer—accordingly, in one embodiment, it may be necessary to know the pitch and roll of the sensor, or this may be measured using another sensor or sensors (e.g., an accelerometer or an accelerometer in combination with a gyroscope); (3) calculate the hard iron offsets; and (4) compare the hard iron offset values with the vehicle profile numerical values 504.

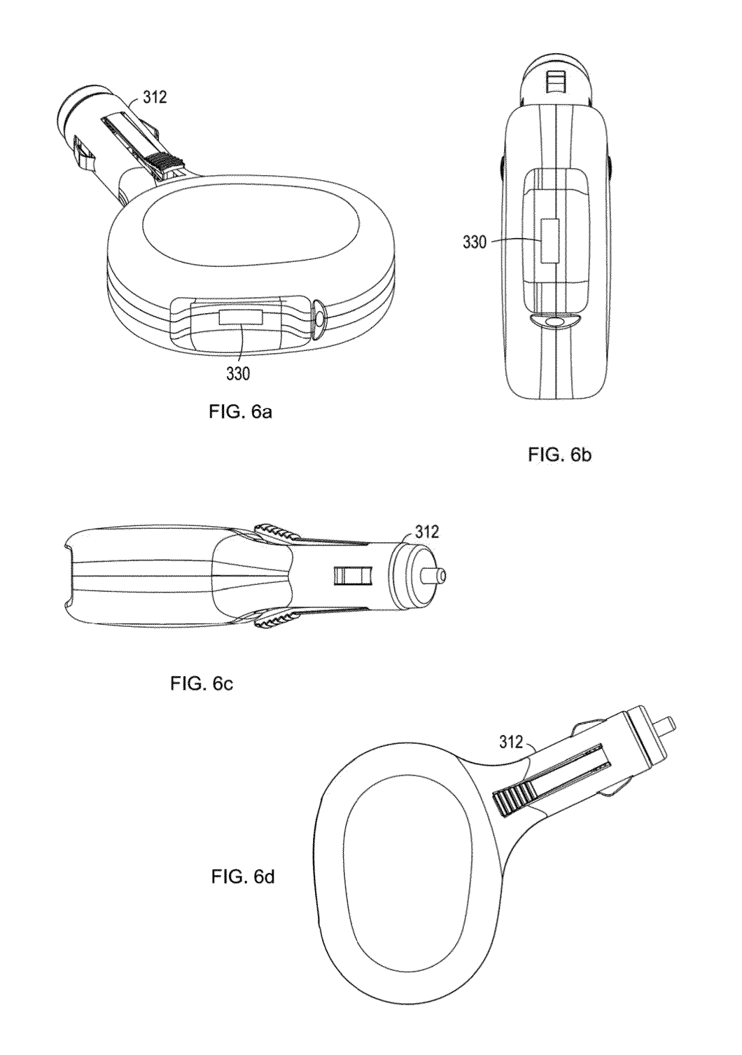

Referring now to FIGS. 6a-6d, one exemplary embodiment of the telematics device 206 is shown from several different angles. Of note, as 12V plug would typically emanate from the hole shown as part of the vehicle interface portion 312, however this is not shown in FIGS. 6a-6d in order to provide an improved view into the telematics device 206. Also, as noted above, in some embodiments, the 12V plug includes gripping means such as rubber pads or gripping tape extended along the axial perimeter of the 12V plug in order to provide for secure installation of the telematics device 206 into the vehicle 202.

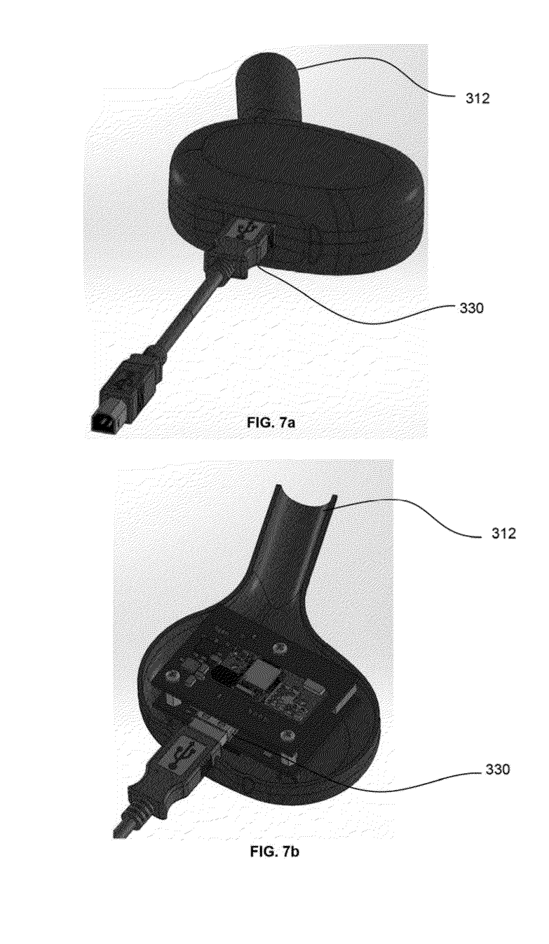

FIG. 7a illustrates an orthographic view of one embodiment of the telematics device 206, this time, with a USB cable inserted into the transceiver(s) 330. FIG. 7b illustrates an orthographic section view of one embodiment of the telematics device 206. In this view, the internal circuitry of the telematics device is shown.

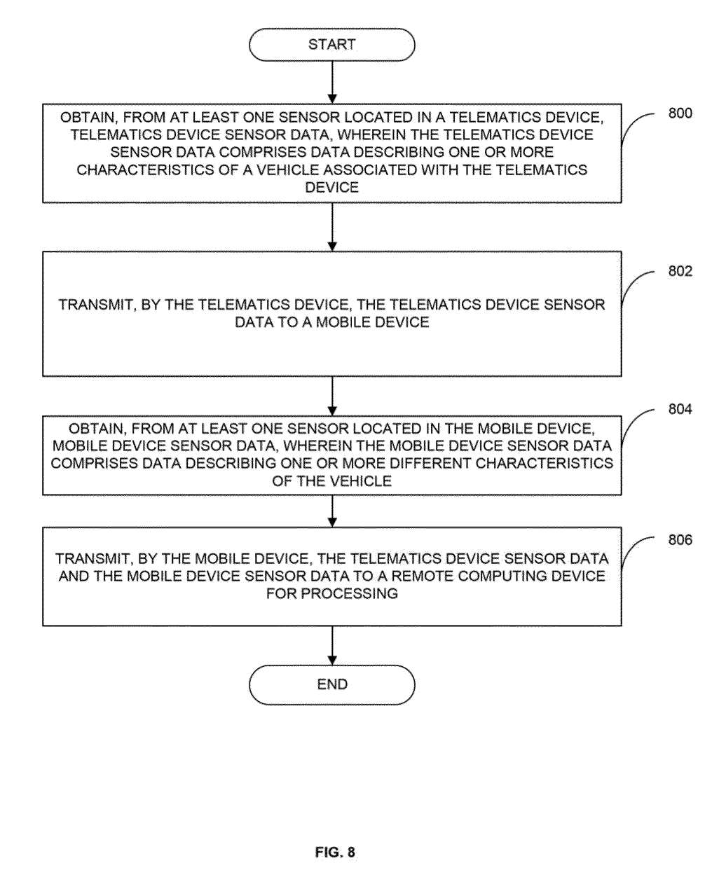

Referring now to FIG. 8, a flow diagram illustrating a method for obtaining and utilizing vehicle telematics data is provided. While the devices 100, 206, 208, 212 are four forms for implementing the processing described herein (including that illustrated in FIG. 8), those having ordinary skill in the art will appreciate that other, functionally equivalent techniques may be employed. Furthermore, as known in the art, some or all of the functionalities implemented via executable instructions may also be implemented using firmware and/or hardware devices such as supplication specific circuits (ASICs), programmable logic arrays, state machines, etc. Once again, those of ordinary skill in the art will appreciate the wide number of variations that may be used in this manner.

Beginning at step 800, telematics device sensor data is obtained from at least one sensor located in a telematics device. The telematics device sensor data may include data describing one or more characteristics of a vehicle associated with the telematics device. At step 802, the telematics device sensor data is transmitted by the telematics device to a mobile device. At step 804, mobile device sensor data is obtained from at least one sensor located in the mobile device. The mobile device sensor data may include data describing one or more different characteristics of the vehicle. Finally, at step 806, the telematics device sensor data and the mobile device sensor data are transmitted to a remote computing device for processing.

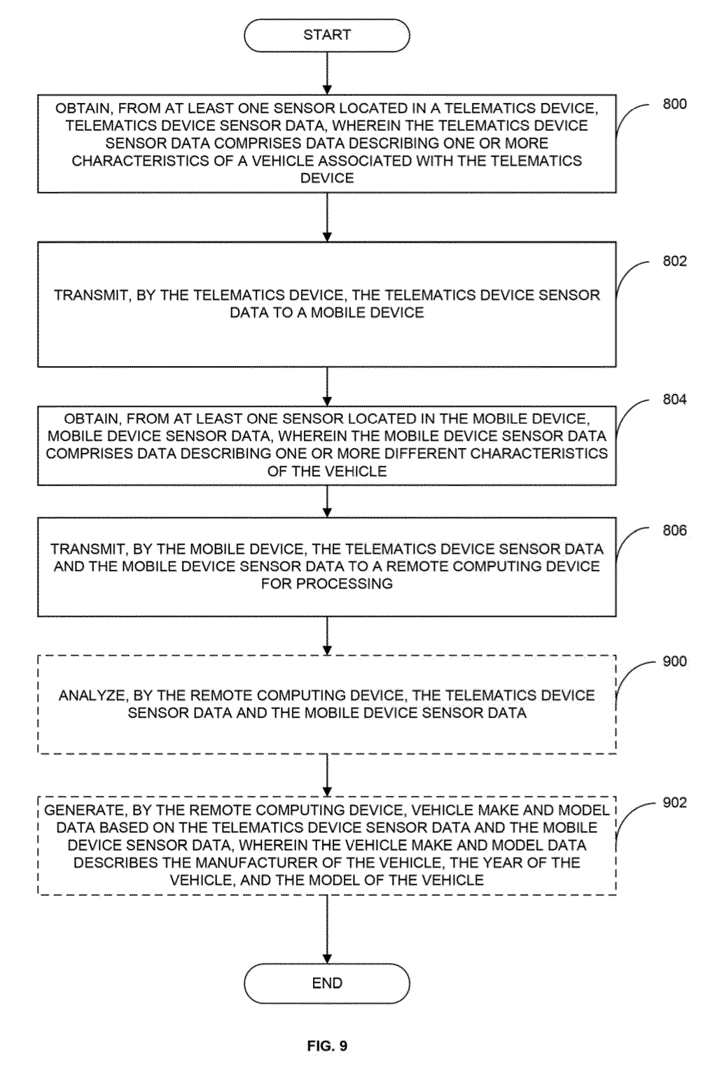

Referring now to FIG. 9, another flow diagram illustrating another exemplary method for obtaining and utilizing vehicle telematics data is provided. Steps 800-806 may be carried out in line with the discussion of those steps provided with regard to FIG. 8. At step 900, the telematics device sensor data and the mobile device sensor data are analyzed by the remote computing device. At step 902, vehicle make and model data is generated by the remote computing device based on the telematics device sensor data and the mobile device sensor data. The vehicle make and model data may include data describing the manufacturer of the vehicle, the year of the vehicle, and the model of the vehicle.

Referring now to FIG. 10, a flow diagram illustrating a method for determining the angle of tilt between a telematics device installed in a vehicle and a vertical plane is provided. At step 1000, accelerometer sensor values are recorded while the telematics device/mobile device are at rest. At step 1002, the angles between the sensor axes and gravity (α, β, & γ) are calculated as the gravity vector is vertically downward. At step 1004, the angle between each sensor axis and the horizontal plane perpendicular to gravity (90° from gravity vector) is calculated. At step 1006, the components of the three sensor readings that are projected on the horizontal plane are calculated. At step 1008, the three sensor projected sensor components are added together to determine the resultant vector plane in the horizontal plane. At step 1010, sensor data (e.g., telematics device sensor data 318 and/or mobile device sensor data 420) are collected for several vehicle trips. At step 1012, the sensor data collected over the several trips is analyzed in order to, for example, collect statistics on acceleration vectors in the horizontal plane. At step 1014, the direction of greatest frequency in the horizontal plane is calculated. Finally, at step 1016, other sensors are corrected/re-calibrated with the direction angles determined in step 1014.

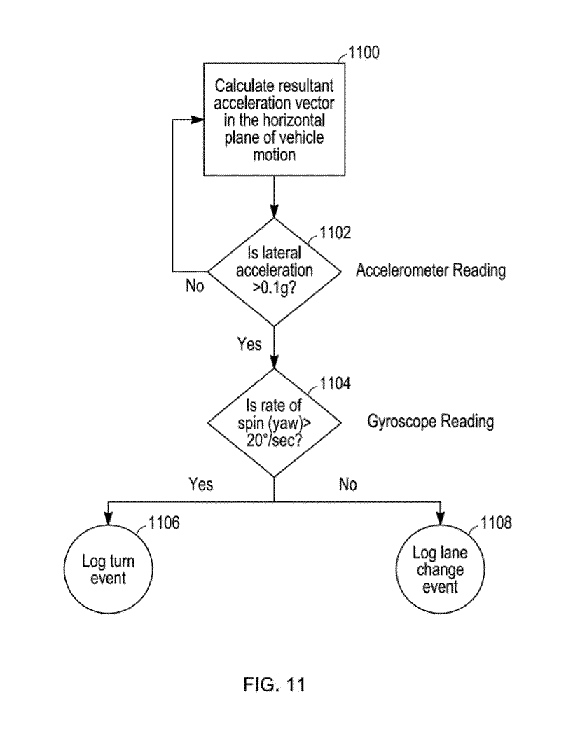

Referring now to FIG. 11, a flow diagram illustrating a method for determining whether a vehicle in which a telematics device is installed executed a turn or merely executed a lane change is provided. Beginning at step 1100, a resultant acceleration vector is calculated in the horizontal plane of vehicle motion based on sensor data obtained from the telematics device and/or the mobile device. At step 1102, a determination is made as to whether the lateral acceleration is greater than 0.1 g—if not, the method reverts back to step 1100. At step 1104, a determination is made as to whether the rate of spin (i.e., yaw) is greater than 20°/second. If not, the method proceeds to step 1108 where the vehicle's motion is recorded as a lane change event. If it is determined that the rate of spin is greater than 20°/second, the method proceeds to step 1106 where the vehicle's motion is recorded as a turn event.

Thus, generally, the method described above with regard to FIG. 11 may be summarized as follows. Gyroscope readings are used in conjunction with accelerometer readings to indicate the difference between a vehicle turn (high gyroscope yaw) versus a lane change (no gyroscope yaw). High gyroscope yaw values are used in combination with accelerometer data to indicate a fast acceleration or hard stop event. Combining with magnetometer data can further affirm the difference between a turn and lane change, as a significant change in heading is associated with a turn. Additional comparison with velocity, integrated from forward acceleration or from GPS speed data, may be used to characterize the severity of the maneuver (that is whether the motions are occurring at high or low speeds.) GPS position, heading and velocity data received from satellites provide an additional verification data stream for motion characterization.

Referring now to FIG. 12, a diagram illustrating sensor orientation and gravity calibration for orienting and calibrating the one or more sensors in the telematics device and/or mobile device is provided. Calibration an orientation may be accomplished in line with the discussion that follows.

OBD ports exist in many locations and orientations through automobiles. In order to correctly characterize the vehicle motion it is first necessary to understand the relationship between the vehicle reference system and that of the OTD. This relationship is developed through an initial gravity calibration that is refined over time through vehicle motion.

Initial angles between the three Cartesian axes of the accelerometer sensor and the gravity vector are calculated from the initial reading of the sensor, which is assumed to occur when the vehicle is at rest. From these initial angles, the angles between the sensor axes and that of the plan of motion are calculated by a 90° rotation from the gravity vector. As an initial approximation, the automobile is assumed at rest to reside on a level surface. Geometric calculations are used to characterize the magnitude and direction of accelerometer component vectors in the plane of motion, perpendicular to gravity.

These calculations are made as follows.

1: Let the accelerometer readings on the component axes (the device axes) be designated as x, y and z, respectively.

2: Determine the magnitude of the resultant vector from the telematics device/mobile device accelerometer component axes (designate R) as: R=SQRT (x²+y²+z²).

3: Determine the angle between each device axis and “down” as indicated by the accelerometer readings when the vehicle is at rest. These may be designated as: (i) α—The angle between the device x-axis and down; (ii) β—The angle between the device y-axis and down; and (iii) γ—The angle between the device z-axis and down. In the foregoing, cos(α)=x/R, cos(β)=y/R and cos(γ)=z/R. These relationships must be altered to account for positive or negative values of x, y, z, and R.

4: Determine the angles between the telematics device/mobile device axes and the ground plane, defined as perpendicular to the gravity vector. This is done by adding or subtracting 90° from α, β, and γ depending on whether the angles are obtuse or acute. If all three positive directions for the device axes are pointed opposite of the gravity vector, 90° is subtracted from all three angles. Call these angles between the telematics device/mobile device x, y and z axes, a, b and c respectively.

5: Select 2 axes (x and y here) and assign a unit value extending in the positive direction of the axes, denoted as x′ and y′. Project those axes onto the ground plane. This will create a trimetric projection in the most general case where a≠b≠c. The irregular pentahedron created has it's vertex at point (0, 0, 0) at the intersection between the ground reference coordinate system and that of the device. The base creates a triangle on the ground plane. Denote the angle on the ground plane in the vertex as A.

6: Examine the trapezoid formed by the open end of the pentahedron. The length of the top edge of the trapezoid is SQRT(2), since the length of the two other sides of the top triangle are 1 (the unit lengths of x′ and y′ with a right angle between). The two sides, which correspond to the distance between the end of the unit vectors x′ and y′ are at 90° angles to the base, which exists in the ground plane. Designate the length of the sides of the triangle in the ground plane, projected from x′ and y′ as x′p and y′p, respectively. The lengths of these sides are related to the angles a and b as: (i) cos(a)=x′p/x′=x′p/l and (ii) cos(b)=y′p/y′=y′p/l.

7: Examine the triangle formed by the top portion of the trapezoid. The base (call it B) of the triangle is the same as the base of the trapezoid, since both sides are of the trapezoid are parallel and perpendicular to the ground plane. The length of the triangle side (denoted H) is the difference between the height of the trapezoid sides or: H=|sin(a)−sin(b)|. From above, the hypotenuse of this triangle is given as SQRT(2). Now, calculate the base of the triangle as: B²+H²=(SQRT(2))² and B=SQRT(2−H²).

8: Now, re-examine the triangle projected onto the ground plane. The length of the three sides are calculated from above to be: a=cos(a), b=cos(b), and c=B. Next, the law of cosines is used to determine the angle formed opposite B (“θ”), which is the angle between the projection of x′ and y′ onto the ground plane: cos(θ)=((cos(a))²+cos(b))²−B²)/(2*cos(a)*cos(b)).

9: Construct similar pentahedrons for the volumes created be projections on the ground plane between the y and z axes and z and x axes of the device. From those constructions, determine the angles on the ground plane between the y and z device axes (Φ) and z and x axes (δ). Note that, θ+Φ+δ=360°, when the positive direction of all 3 device axes of the device are point in either the direction towards or opposite that of the gravity vector (i.e. all 3 device axes point upwards or down). If one device axis points opposite the other two with respect to the gravity vector (e.g. x and y point upwards and z points down), the sum of the two acute projection angles will equal the third obtuse angle.

10: Now that the projections of the x, y and z axes of the device onto the ground plane are know, vector sums may be calculated while the vehicle is in motion from components of the accelerometer vectors that exist in the ground plane. To build the calibration over time, begin with the assumption that the forward axis of the vehicle coincides with one axis of the device, say x. Utilizing θ, Φ and δ, calculate vector sums of xp, yp and zp to determine the magnitude and direction of the resultant vector existing in the ground plane.

Through the first several trips of the telematics device/mobile device equipped vehicle, the resultant vectors in the plane of motion are calculated for magnitude and direction from above. The highest frequency of acceleration motions will occur along the forward-to-backward axis of the vehicle, representing linear acceleration and deceleration. Statistics are compiled on the angles associated with acceleration readings in the plane of motion and those with greatest frequencies are selected as the angles between the sensor axes and the vehicle forward to backward axis. As additional trip data is compiled the gravity angles and estimated forward to backwards angles are continually averaged to approach the true value of tilt between the telematics device/mobile device and the vehicle. Over time, this provides for compensation for errors due to vehicle position on other than flat surfaces, as the assumption is made that, over a period of time, the vehicle is on average in an orientation perpendicular to gravity.

Calibration of a Telematics Device of Unknown Orientation to the Chassis of a Moving Vehicle

In one exemplary embodiment, the telematics device/mobile device may be calibrated as follows. While the method that follows is expressed in a series of numbered steps, those having ordinary skill in the art will appreciate that, in certain instances, the following steps may suitably be performed in a different order. In addition, in certain embodiments, one or more of the following steps may be omitted entirely without deviating from the general calibration process.

Step 1: Calculate average of all accelerometer readings on each axis. These values are demoted as Xave, Yave, and Zave respectively. Typically, the more data, the better the calibration. The underlying assumption is that over many readings, the car is on average horizontal.

Step 2: Calculate the Average Magnitude, denoted as Mₐᵥₑ. This value is the square root of the sum of the squares of the individual axis average values.

Step 3: Calculate the angle between the axis average values and average magnitude (x, y, z) as (α, β, γ) where: (a) α=cos⁻¹(|Xₐᵥₑ|/Mₐᵥₑ); (b) β=cos⁻¹(|Yₐᵥₑ|/Mₐᵥₑ); and (c) γ=cos⁻¹(|Zₐᵥₑ|/Mₐᵥₑ).

Regarding the foregoing, it is noted that absolute values are used because, on average, all force vectors, regardless of the sign on the accelerometer reading, will be pointed opposite of the gravity vector (up). The Mₐᵥₑ is likewise always up, but is positive in all cases due to the equation used to calculate.

Step 4: Calculate the angle between the Axis averages and the horizontal plane by subtracting α, β and γ from π/2. Note, on average all force vectors, regardless of the sign on the accelerometer reading, will be pointed opposite of the gravity vector (up), so α, β and γ will be less than 90°.

Step 5: Determine the angles between the average values of the 3 axis values projected in the horizontal plane. Note, over many readings, due to the assumption in step 1 above, the average values of the individual axes projected into the horizontal plane will represent the projected sensor values of the car at rest on a surface perpendicular to gravity.

Step 6: Calculate the absolute value of the components of each accelerometer value in the horizontal plane, maintaining their signs as follows: (a) |Xₚ|=|accel_x*cos(π/2−α)|; (b) |Yₚ|=|accel_y*cos(π/2−β)|; and (c) |Zₚ|=|accel_z*cos(π/2−γ)|.

Step 7: Beginning from the projection of the positive sensor X axis, as viewed from above the horizontal plane, let: (a) a be the angle measured clockwise to the next projected axis; (b) b be the angle measured clockwise to the next projected axis; and (c) c be the angle measured clockwise to the next projected axis, which will be X in the negative direction.

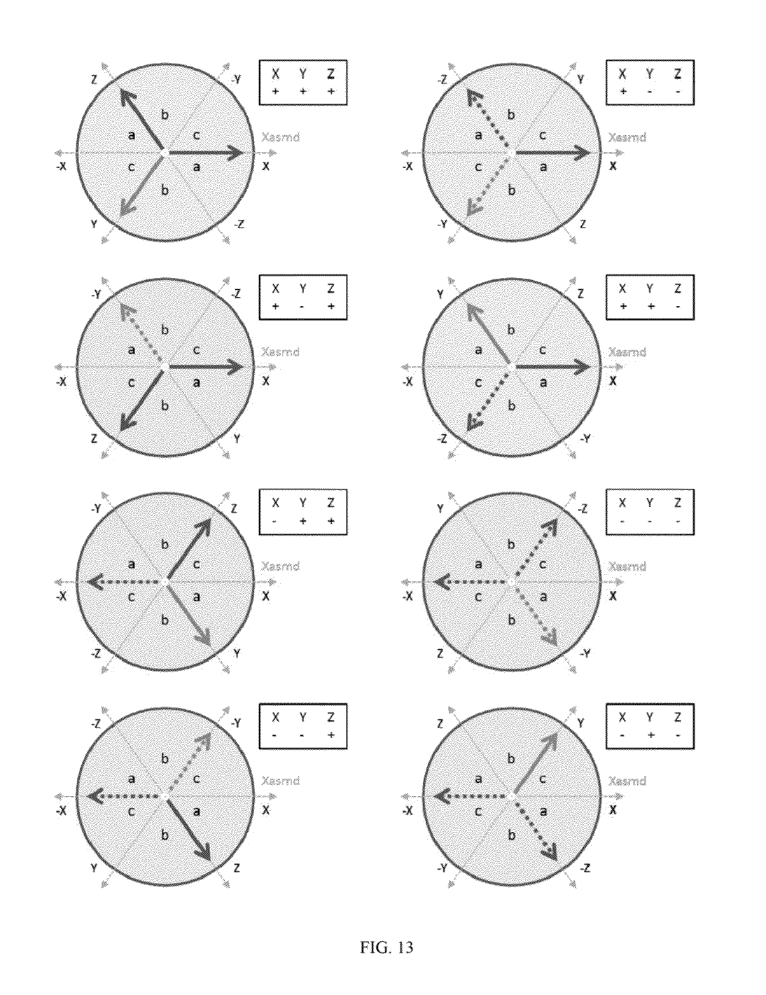

Note, a+b+c will, by definition, =π. See the Table A to determine which axis this will be, as determined by the device orientation, indicated by the sign on the average values of the sensor readings in each axis. Device Orientation Cases are taken from the sign of Xₐᵥₑ, Yₐᵥₑ, and Zₐᵥₑ respectively. Graphical representation of the relationships are shown in FIG. 13.

TABLE A
Positioning of Angles Between Projected Axes as Measured
from above the Horizontal Plane by Orientation Case

| | | |
|---|---|---|
| a | b | c |

| Case | From | To | From | To | From | To |
|---|---|---|---|---|---|---|
| +++ | X | −Z | −Z | Y | Y | −X |
| +−− | X | Z | Z | −Y | −Y | −X |
| +−+ | X | Y | Y | Z | Z | −X |
| ++− | X | −Y | −Y | −Z | −Z | −X |
| −++ | X | Y | Y | −Z | −Z | −X |
| −−− | X | −Y | −Y | Z | Z | −X |
| −−+ | X | Z | Z | Y | Y | −X |
| −+− | X | −Z | −Z | −Y | −Y | −X |

In FIG. 13, angles a, b, and c are viewed from above the horizontal plane, X, Y and Z are right-handed orthogonal axes of sensors, solid lines are on positive axes, dashed lines are on negative axes, and the circle represents the plane perpendicular to gravity as viewed from above.

Step 8: Determine the values of angles a, b, and c. There are 2 possible set of values, depending on the device orientation. The governing relationships for the 2 Value Sets are based on the fact that at rest on a perfectly level surface, forces in the plane perpendicular to gravity sum to zero. The Value Sets are given as follows:

Value Set 1: (i) |Xₚ|=cos(a)*|Yₚ|+cos(c)*αZₚ|; (ii) |Yₚ|=cos(a)*|Xₚ|+cos(b)*|Zₚ|; and (iii) |Zₚ|=cos(c)*|Xₚ|+cos(b)*|Yₚ|.

Value Set 2: (i) |Xₚ|=cos(c)*|Yₚ|+cos(a)*|Zₚ|; (ii) |Yₚ|=cos(c)*|Xₚ|+cos(b)*|Zₚ|; and (iii) |Zₚ|=cos(a)*|Xₚ|+cos(b)*|Yₚ|.

Let a, b and c for each case be denoted a_{Sx}, b_{Sx} and c_{Sx}, where “x” represents the Set number. From the above, it follows that:

a_{S1}=cos⁻¹((|Xₚ|−cos(c)*|Zₚ|)/|Yₚ|);

b_{S1}=cos⁻¹((−Xₚ²+Yₚ²+cos(c)*|Xₚ|*|Zₚ|)/(|Yₚ|*|Zₚ|)); and

c_{S1}=cos⁻¹((Xₚ²−Yₚ²+Zₚ²)/(2*|Xₚ|*|Zₚ|)).

Now, note that a is substituted for c in the Case equations and the values are simply substituted, so that: (i) a_{S1}=c_{S2}; (ii) b_{S1}=b_{S2}; and (iii) c_{S1}=a_{S2}.

Value Sets may be assigned to the possible orientation cases as shown in Table B below.

TABLE B
Association of a, b, c Value Set to Device Orientation Case

| Case | Value Set |
|---|---|
| + + + | 1 |
| + − − | 2 |
| + − + | 1 |
| + + − | 2 |
| − + + | 1 |
| − − − | 2 |
| − − + | 1 |
| − + − | 1 |

Step 9: Calculate the resultant vector of the Xₚ, Yₚ and Zₚ components along the line of the sensor +X axis projected into the horizontal plane. Let this direction be +X_{ASSUMED}. The magnitudes of these components are given in Table C below.

TABLE C
Magnitude of components along the projected X (X_{ASSUMED}) axis.

| Case | Xₓ | Yₓ | Zₓ |
|---|---|---|---|
| + + + | Xₚ | Yₚ * cos(c) | Zₚ * cos(a) |
| + − − | Xₚ | Yₚ * cos(c) | Zₚ * cos(a) |
| + − + | Xₚ | Yₚ * cos(a) | Zₚ * cos(c) |
| + + − | Xₚ | Yₚ * cos(a) | Zₚ * cos(c) |
| − + + | Xₚ | Yₚ * cos(a) | Zₚ * cos(c) |
| − − − | Xₚ | Yₚ * cos(a) | Zₚ * cos(c) |
| − − + | Xₚ | Yₚ * cos(c) | Zₚ * cos(a) |
| − + − | Xₚ | Yₚ * cos(c) | Zₚ * cos(a) |

Step 10: Calculate the resultant vector of the Xₚ, Yₚ and Zₚ components along a line rotated π/2 counter-clockwise from the sensor +X axis projected into the horizontal plane, as viewed from above the horizontal plane. Let this direction be +Y_{ASSUMED}. The magnitudes of these components are given in Table D below.

TABLE D
Magnitude of components along the Y_{ASSUMED} axis.

| Case | X_{y} | Y_{y} | Z_{y} |
|---|---|---|---|
| + + + | 0 | Yₚ * sin(c) | Zₚ * sin(a) |
| + − − | 0 | Yₚ * sin(c) | Zₚ * sin(a) |
| + − + | 0 | Yₚ * sin(a) | Zₚ * sin(c) |
| + + − | 0 | Yₚ * sin(a) | Zₚ * sin(c) |
| − + + | 0 | Yₚ * sin(a) | Zₚ * sin(c) |
| − − − | 0 | Yₚ * sin(a) | Zₚ * sin(c) |
| − − + | 0 | Yₚ * sin(c) | Zₚ * sin(a) |
| − + − | 0 | Yₚ * sin(c) | Zₚ * sin(a) |

Step 11: Sum the component contributions from each of the projected sensor readings in the directions of X_{ASSUMED} and Y_{ASSUMED}. Minding the signs associated with the orientation of the device, these will add as shown in Table E below.

TABLE E
Resultant equations for adding components
in the X_{ASSUMED} and Y_{ASSUMED} axes.

| Case | X_{ASSUMED} | Y_{ASSUMED} |
|---|---|---|
| + + + | Xₓ − Yₓ − Zₓ | −Y_{y} + Z_{y} |
| + − − | Xₓ + Yₓ + Zₓ | Y_{y} − Z_{y} |
| + − + | Xₓ + Yₓ − Zₓ | −Y_{y} − Z_{y} |
| + + − | Xₓ − Yₓ + Zₓ | Y_{y} + Z_{y} |
| − + + | Xₓ + Yₓ + Zₓ | −Y_{y} + Z_{y} |
| − − − | Xₓ − Yₓ − Zₓ | Y_{y} − Z_{y} |
| − − + | Xₓ − Yₓ + Zₓ | −Y_{y} − Z_{y} |
| − + − | Xₓ + Yₓ − Zₓ | Y_{y} + Z_{y} |

Step 12: Calculate the resultant vector as SQRT (X_{ASSUMED}²+Y_{ASSUMED}²). Let this value be R_{MAG}.

Step 13: Calculate the counter-clockwise rotation of the resultant vector from the following Table F. Let this value be R_{ANGLE}.

TABLE F
Equations for calculation of R_{ANGLE.}

| X_{ASSUMED} | Y_{ASSUMED} | |
|---|---|---|
| Sign | Sign | R_{ANGLE} |
| + | + | cos⁻¹(X_{ASSUMED}/R_{MAG}) |
| + | − | cos⁻¹(X_{ASSUMED}/R_{MAG}) |
| − | + | 2π − cos⁻¹(X_{ASSUMED}/R_{MAG}) |
| − | − | 2π − cos⁻¹(X_{ASSUMED}/R_{MAG}) |

Step 14: Collect and analyze driving acceleration data according to the above treatment. Accumulate individual values of R_{MAG} by R_{ANGLE}. Over time the maximum accumulated values will be at 2 values of R_{ANGLE} that are 180° apart from one another. These values of R_{ANGLE} indicate the forward and readward directions of the automobile axis, as measured from X_{ASSUMED}. For typical drivers, the maximum accumulated value will indicate the forward direction of the automobile axis, since sensor readings are opposite of applied forces and braking may be to be assumed as more severe than acceleration in most cases. R_{ANGLE}+/−90° will indicate left or right lateral directions of the auto axis.

Certain embodiments of this technology are described above with reference to block and flow diagrams of computing devices and methods and/or computer-readable media according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any devices or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method comprising:
obtaining, from at least one sensor located in a telematics device, telematics device sensor data, wherein the telematics device sensor data comprises data describing one or more characteristics of a vehicle associated with the telematics device;
transmitting, by the telematics device, the telematics device sensor data to a mobile device;
obtaining, from at least one sensor located in the mobile device, mobile device sensor data, wherein the mobile device sensor data comprises data describing one or more different characteristics of the vehicle; and
transmitting, by the mobile device, the telematics device sensor data and the mobile device sensor data to a remote computing device for processing.

2. The method of claim 1, further comprising:
analyzing, by the remote computing device, the telematics device sensor data and the mobile device sensor data; and
generating, by the remote computing device, vehicle make and model data based on the telematics device sensor data and the mobile device sensor data, wherein the vehicle make and model data describes a manufacturer of the vehicle, a year of the vehicle, and a model of the vehicle.

3. The method of claim 2, wherein the telematics device sensor data and the mobile device sensor data comprise one or more numerical values, and wherein analyzing the telematics device sensor data and the mobile device sensor data comprises comparing the one or more numerical values with corresponding one or more vehicle profile numerical values stored in a vehicle profile database.

4. The method of claim 1, further comprising:
processing, by one or more processors located in the mobile device, the telematics device sensor data and the mobile device sensor to provide display data; and
outputting, for display, the display data.

5. The method of claim 1, wherein the telematics device sensor data comprises at least one of:
accelerometer data, wherein the accelerometer data is obtained from an accelerometer sensor located in the telematics device, and wherein the accelerometer data describes acceleration of the vehicle at one or more points in time;
gyroscope data, wherein the gyroscope data is obtained from a gyroscope sensor located in the telematics device, and wherein the gyroscope data describes an orientation of the vehicle at one or more points in time;
magnetometer data, wherein the magnetometer data is obtained from a magnetometer sensor located in the telematics device, and wherein the magnetometer data describes a direction of the vehicle at one or more points in time; and
location data, wherein the location data is obtained from a location-detecting sensor located in the telematics device, and wherein the location data describes a location of the vehicle at one or more points in time.

6. The method of claim 1, wherein the mobile device sensor data comprises at least one of:
accelerometer data, wherein the accelerometer data is obtained from an accelerometer sensor located in the mobile device, and wherein the accelerometer data describes acceleration of the vehicle at one or more points in time;
gyroscope data, wherein the gyroscope data is obtained from a gyroscope sensor located in the mobile device, and wherein the gyroscope data describes an orientation of the vehicle at one or more points in time;
magnetometer data, wherein the magnetometer data is obtained from a magnetometer sensor located in the mobile device, and wherein the magnetometer data describes a direction of the vehicle at one or more points in time; and
location data, wherein the location data is obtained from a location-detecting sensor located in the mobile device, and wherein the location data describes a location of the vehicle at one or more points in time.

7. The method of claim 1, further comprising:
installing the telematics device in the vehicle, wherein installing comprises connecting a vehicle interface portion of the telematics device to a telematics interface portion of the vehicle.

8. The method of claim 7, further comprising:
uninstalling the telematics device from the vehicle, wherein uninstalling comprises:
disconnecting the vehicle interface portion of the telematics device from the telematics interface portion of the vehicle; and
switching a power source for the telematics device from a first power source external to the telematics device to a second power source internal to the telematics device.

9. The method of claim 1, wherein transmitting the telematics device sensor data to the mobile device comprises transmitting the telematics device sensor data via a wireless communication channel.

10. The method of claim 1, wherein transmitting the telematics device sensor data to the mobile device comprises transmitting the telematics device sensor data via a universal serial bus (USB) communication channel.

11. The method of claim 1, further comprising at least one of:
compressing at least one of the telematics device sensor data and the mobile device sensor data; and
encrypting at least one of the telematics device sensor data and the mobile device sensor data.

12. The method of claim 1, further comprising:
adjusting a rate at which the telematics device sensor data is obtained from the at least one sensor located in the telematics device.

13. The method of claim 1, further comprising:
adjusting a rate at which the mobile device sensor data is obtained from the at least one sensor located in the mobile device.

14. A telematics device comprising:
at least one sensor configured to generate telematics device sensor data, wherein the telematics device sensor data comprises data describing one or more characteristics of a vehicle associated with the telematics device;
a transceiver operatively connected to the at least one sensor, wherein the transceiver is configured to transmit the telematics device sensor data over at least one of: a wired communication channel and a wireless communication channel; and
a vehicle interface portion, wherein the vehicle interface portion is configured to connect to a telematics interface portion of the vehicle.

15. The telematics device of claim 14, wherein the at least one sensor comprises at least one of:
an accelerometer sensor configured to obtain accelerometer data, wherein the accelerometer data describes acceleration of the vehicle at one or more points in time;
a gyroscope sensor configured to obtain gyroscope data, wherein the gyroscope data describes an orientation of the vehicle at one or more points in time;
a magnetometer sensor configured to obtain magnetometer data, wherein the magnetometer data describes a direction of the vehicle at one or more points in time; and
a location sensor configured to obtain location data, wherein the location data describes a location of the vehicle at one or more points in time.

16. The telematics device of claim 14, wherein the vehicle interface portion comprises a twelve-volt plug and wherein the telematics interface portion of the vehicle comprises a twelve-volt outlet.

17. The telematics device of claim 14, further comprising:
a battery configured to supply power to at least one of the at least one sensor and the transceiver when the telematics device is uninstalled from the vehicle.

18. The telematics device of claim 14, further comprising:
a compression module operatively connected to the transceiver, wherein the compression module is configured to compress the telematics device sensor data prior to transmission via the transceiver; and
an encryption module operatively connected to the transceiver, wherein the encryption module is configured to encrypt the telematics device sensor data prior to transmission via the transceiver.

19. The telematics device of claim 14, further comprising:
memory operatively connected to the transceiver, wherein the memory is configured to store the telematics device sensor data.

20. The telematics device of claim 14, wherein the vehicle interface portion comprises means for securely connecting with the telematics interface portion of the vehicle.

21. The telematics device of claim 20, wherein the means comprise at least one of gripping tape and one or more rubber pads.

22. A mobile device comprising:
a telematics device interface, wherein the telematics device interface is configured to obtain telematics device sensor data from a telematics device, and wherein the telematics device sensor data comprises data describing one or more characteristics of a vehicle associated with the telematics device;
at least one sensor configured to generate mobile device sensor data, wherein the mobile device sensor data comprises data describing one or more different characteristics of the vehicle; and
a transceiver operatively connected to the telematics device interface and the at least one sensor, the transceiver configured to transmit the telematics device sensor data and the mobile device sensor data to a remote computing device for processing.

23. The mobile device of claim 22, further comprising:
memory operatively connected to the at least one sensor, the memory configured to store the telematics device sensor data and the mobile device sensor data; and
one or more processors, the one or more processors configured to process the telematics device sensor data and the mobile device sensor data to provide display data; and
a display device operatively connected to the one or more processors, the display device configured to display the display data.

24. The mobile device of claim 22, wherein the at least one sensor comprises at least one of:
an accelerometer sensor configured to obtain accelerometer data, wherein the accelerometer data describes acceleration of the vehicle at one or more points in time;
a gyroscope sensor configured to obtain gyroscope data, wherein the gyroscope data describes an orientation of the vehicle at one or more points in time;
a magnetometer sensor configured to obtain magnetometer data, wherein the magnetometer data describes a direction of the vehicle at one or more points in time; and
a location sensor configured to obtain location data, wherein the location data describes a location of the vehicle at one or more points in time.

25. The mobile device of claim 22, further comprising:
a compression module operatively connected to the transceiver, wherein the compression module is configured to compress at least one of the telematics device sensor data and the mobile device sensor data prior to transmission via the transceiver; and
an encryption module operatively connected to the transceiver, wherein the encryption module is configured to encrypt at least one of the telematics device sensor data and the mobile device sensor data prior to transmission via the transceiver.

26. A system comprising:
a telematics device comprising:
at least one telematics device sensor configured to generate telematics device sensor data, wherein the telematics device sensor data comprises data describing one or more characteristics of a vehicle associated with the telematics device;
a transceiver operatively connected to the at least one telematics device sensor, wherein the transceiver is configured to transmit the telematics device sensor data over at least one of: a wired communication channel and a wireless communication channel; and
a vehicle interface portion, wherein the vehicle interface portion is configured to connect to a telematics interface portion of the vehicle;
a mobile device operatively connected to the telematics device, the mobile device comprising:
a telematics device interface configured to obtain the telematics device sensor data from the telematics device;
at least one mobile device sensor configured to generate mobile device sensor data, wherein the mobile device sensor data comprises data describing one or more different characteristics of the vehicle; and
a transceiver operatively connected to the telematics device interface and the at least one mobile device sensor, the transceiver configured to transmit the telematics device sensor data and the mobile device sensor data.

27. The system of claim 26, further comprising:
a remote computing device operatively connected to the mobile device, wherein the remote computing device comprises:
a sensor data analysis module, the sensor data analysis module configured to:
analyze the telematics device sensor data and the mobile device sensor data; and
generate vehicle make and model data based on the telematics device sensor data and the mobile device sensor data, wherein the vehicle make and model data describes a manufacturer of the vehicle, a year of the vehicle, and a model of the vehicle.

28. The system of claim 27, wherein the telematics device sensor data and the mobile device sensor data comprise one or more numerical values, and wherein the sensor data analysis module is configured to analyze the telematics device sensor data and the mobile device sensor data by comparing the one or more numerical values with corresponding one or more vehicle profile numerical values stored in a vehicle profile database.

29. The system of claim 27, wherein the telematics device sensor data comprises at least one of:
accelerometer data, wherein the accelerometer data is obtained from an accelerometer sensor located in the telematics device, and wherein the accelerometer data describes acceleration of the vehicle at one or more points in time;
gyroscope data, wherein the gyroscope data is obtained from a gyroscope sensor located in the telematics device, and wherein the gyroscope data describes an orientation of the vehicle at one or more points in time;
magnetometer data, wherein the magnetometer data is obtained from a magnetometer sensor located in the telematics device, and wherein the magnetometer data describes a direction of the vehicle at one or more points in time; and
location data, wherein the location data is obtained from a location-detecting sensor located in the telematics device, and wherein the location data describes a location of the vehicle at one or more points in time.

30. The system of claim 27, wherein the mobile device sensor data comprises at least one of:
accelerometer data, wherein the accelerometer data is obtained from an accelerometer sensor located in the telematics device, and wherein the accelerometer data describes acceleration of the vehicle at one or more points in time;
gyroscope data, wherein the gyroscope data is obtained from a gyroscope sensor located in the telematics device, and wherein the gyroscope data describes an orientation of the vehicle at one or more points in time;
magnetometer data, wherein the magnetometer data is obtained from a magnetometer sensor located in the telematics device, and wherein the magnetometer data describes a direction of the vehicle at one or more points in time; and
location data, wherein the location data is obtained from a location-detecting sensor located in the telematics device, and wherein the location data describes a location of the vehicle at one or more points in time.

31. A computer-readable medium encoded with a computer program, the computer program comprising computer-executable instructions that when executed by a computer having at least one processor causes the computer to perform a method comprising:
obtaining telematics device sensor data from a telematics device, wherein the telematics device sensor data comprises data describing one or more characteristics of a vehicle associated with the telematics device;
obtaining mobile device sensor data, wherein the mobile device sensor data comprises data describing one or more different characteristics of the vehicle;
processing the telematics device sensor data and the mobile device sensor data to provide display data; and
outputting, for display, the display data.

32. The computer-readable medium of claim 31 wherein the computer-executable instructions further cause the computer to:
compress at least one of the telematics device sensor data and the mobile device sensor data; and
encrypt at least one of the telematics device sensor data and the mobile device sensor data.
